(19) United States
(12) Patent Application Publication
(10) Pub. No.: US 2006/0176554 A1
(43) Pub. Date: Aug. 10, 2006

(54) Holographic louver device for a light guide screen

(76) Inventors: Huei-Pei Kuo, Cupertino, CA (US); Laurence Hubby, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/052,605

(22) Filed: Feb. 7, 2005

(51) Int. Cl. G03B 21/56

(52) U.S. Cl. 359/460; 385/115

(57) ABSTRACT

A light guide screen louver device. In a particular embodiment, the device includes a translucent layer of material having an inner surface and, parallel thereto, an outer surface. A plurality of reflective louver members are disposed within the layer of material. The louver members are aligned to receive light entering the inner surface from the light guide screen at a low angle relative to the inner surface and direct the light out the outer surface at a high angle relative to the outer surface. In at least one embodiment, the louver members are holographic.

### RELATED APPLICATIONS

This application is related to commonly owned U.S. patent application Ser. No.: 10/698829, filed on Oct. 31, 2003 by inventors Huei Pei Kuo, Lawrence M. Hubby, Jr. and Steven L. Naberhuis and entitled “Light Guide Apparatus For Use In Rear Projection Display Environments”, herein incorporated by reference.

### FIELD

This invention relates generally to the field of display devices and, in particular, to a holographic louver device for a light guide screen.

### BACKGROUND

Socially and professionally, most people rely upon video displays in one form or another for at least a portion of their work and/or recreation. With a growing demand for large screens and high definition television (HDTV), cathode ray tubes (CRTs) have largely given way to displays composed of liquid crystal devices (LCDs), plasma display panels (PDPs), and front and rear projection systems.

A CRT operates by scanning electron beam(s) that excite phosphor materials on the back side of a transparent screen, wherein the intensity of each pixel is commonly tied to the intensity of the electron beam. With a PDP, each pixel is an individual light-emitting device capable of generating its own light. With an LCD, each pixel is a transient light-emitting device, individually adjusted to permit light to shine through the pixel.

As neither system utilizes a large tube, LCD and PDP screens may be quite thin and often are lighter than comparable CRT displays. However, the manufacturing process for LCDs, PDPs, and most other flat panel displays is much more complex and intensive with respect to both equipment and materials than that of CRTs, typically resulting in higher selling prices.

Projection systems offer alternatives to PDP and LCD based systems. In many cases, projection display systems are less expensive than comparably sized PDP or LCD display systems. With a front projection system, the image is projected onto a screen from the same side as the viewer. If the viewer stands, sits or otherwise blocks the projection the image will be compromised. Front projection systems are therefore often suspended from the ceiling or mounted high upon a rear wall.

To accommodate the projector, one or more lenses, and reflectors, rear projection displays are typically 18 to 20 inches deep and not suitable for on-wall mounting. A typical rear projection system offering a 55-inch HDTV screen may weigh less than a comparable CRT, but at 200+ pounds it may be difficult and awkward to install and support.

Often, rear projection display devices exhibit average or below-average picture quality in certain environments. For example, rear projection displays may be difficult to see when viewed from particular angles within a room setting or when light varies within the environment. Aside from a theatrical setting, light output and contrast are constant issues in most settings and viewing environments.

Despite advancements in projectors and enhanced lens elements, the lens and reflector design remains generally unchanged and tends to be a limiting factor in both picture quality and overall display system thickness.

A developing variation of rear projection displays utilizes light guides, such as optical fibers, to route an image from an input location to an output location, and magnify the image. However, in certain configurations, light guide screens may lose a percentage of light and, thus, the brightness of the image, by permitting the light to venture off in directions other than substantially towards the viewing audience. This loss of light may in some instances amount to fifty percent (50%) of the light provided to the input ends of the light guides.

In addition, in some configurations, the viewing angle of the complete screen may be limited to the angular range corresponding to the acceptance angle of the light guides used in construction of the screen. With respect to light guides, the acceptance angle is the half-angle of the cone within which incident light is totally internally reflected by the fiber core. Further, this range of viewing angles may not be out in front of the screen, but may be more heavily concentrated to the right, left, top or bottom, depending on the direction the light guides approach the screen from behind.

Weight, thickness, durability, cost, aesthetic appearance, and quality are key considerations for rear projection display systems and display screens. As such, there is a need for some device to reduce this loss of light that is likely with a light guide screen.

Hence, there is a need a device that overcomes one or more of the drawbacks identified above.

### SUMMARY

This invention provides a holographic louver device for use with a light guide screen.

In particular, and by way of example only, according to an embodiment of the present invention, provided is a light guide screen louver device including: a translucent layer of material having an inner surface and, parallel thereto, an outer surface; a plurality of reflective louver members disposed within the layer of material, the louver members aligned to receive light entering the inner surface from the light guide screen at a low angle relative to the inner surface and direct the light out the outer surface at a high angle relative to the outer surface; wherein the louver device is configured to join to the light guide screen. In at least one embodiment, the louver members are holographic.

### BRIEF DESCRIPTION OF THE DRAWINGS

FIG. 1 shows a schematic diagram of an embodiment of a rear projection display;

FIG. 2 shows a plane view of a magnifying layer with louver device incorporated in the display shown in FIG. 1;

FIG. 3 is an partial cross section view of a light guide with an embodiment of a louver device as may be used with the magnifying layer of FIG. 2;

FIG. 4 is an partial cross section view of a light guide with another embodiment of a louver device as may be used with the magnifying layer of FIG. 2; and

FIG. 5 is a further enlargement of a light guide with an embodiment of a holographic louver device as may be used with the magnifying layer of FIG. 2.

### DETAILED DESCRIPTION

Before proceeding with the detailed description, it is to be appreciated that the present teaching is by way of example, not by limitation. The concepts herein are not limited to use or application with a specific light guide screen. Thus, although the instrumentalities described herein are for the convenience of explanation, shown and described with respect to exemplary embodiments, it will be appreciated that the principles herein may be equally applied in other types light guide screen display systems.

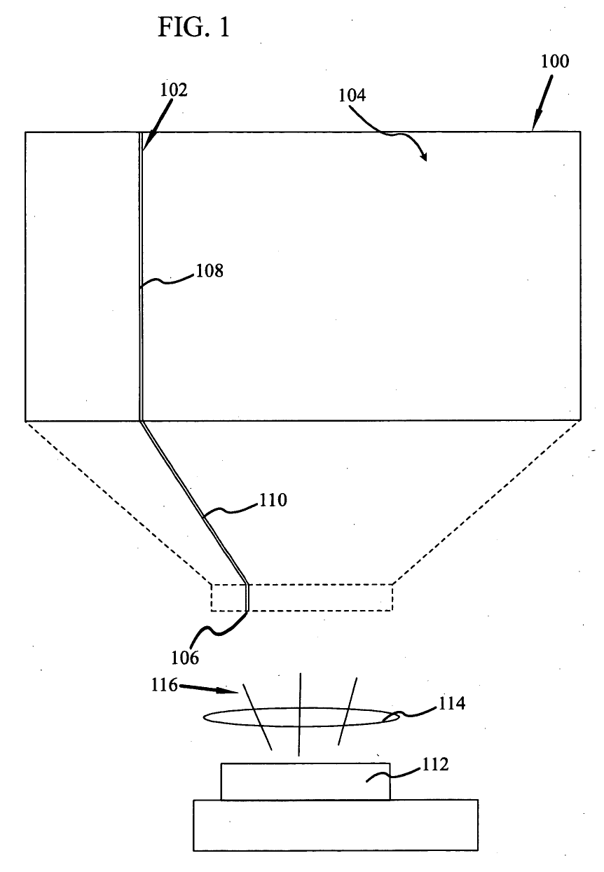

FIG. 1 conceptually illustrates a portion of a light guide screen (LGS) 100. In at least one embodiment, LGS 100 has a plurality of aligned magnifying layers 102 providing a viewing surface 104. Specifically, the magnifying layers 102 each provide an input location 106, a magnifying output location 108 and, in at least one embodiment, a flexible midsection 110.

As shown, each magnifying layer 102 provides one vertical slice of the viewing surface 104. In an alternative embodiment, not shown, each magnifying layer 102 provides one horizontal slice of the viewing surface 104. A light source 112, is optically coupled to the input location 106 by at least one lens 114. An image provided by light source 112 (such as a projector), and focused by lens 114 upon input location 106 is conveyed by the light guides of each magnifying layer 102 to the viewing surface 104.

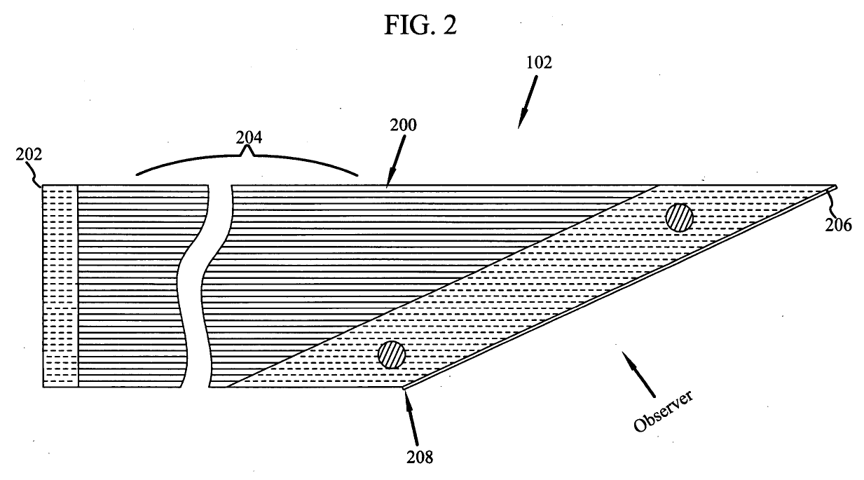

As shown in FIG. 2, each magnifying layer 102 has a plurality of light guides 200. It is understood and appreciated that light guides 200 as used herein are cladded light guides. Each light guide 200 consists of a core that is substantially optically clean and a circumferential cladding, further discussed below with respect to FIG. 4. The core has an index of refraction, n1, and the clad has an index of refraction n2, wherein n1>n2.

Each light guide 200 has an input end 202, a midsection 204 and a magnifying output end 206. In at least one embodiment, the midsection 204 is a flexible midsection. Each magnifying output end 206 is configured to magnify an image presented to the input end 202. The plurality of magnifying output ends 206 are aligned in substantially contiguous parallel contact.

More specifically, the magnifying output ends 206 are in substantially contiguous intimate contact, without intervening spacers or material separating each individual magnifying output end 206 from its neighbors on either side. In other words, the magnifying output ends 206 lie next to one another and are in actual contact, touching along their outer surfaces at a point.

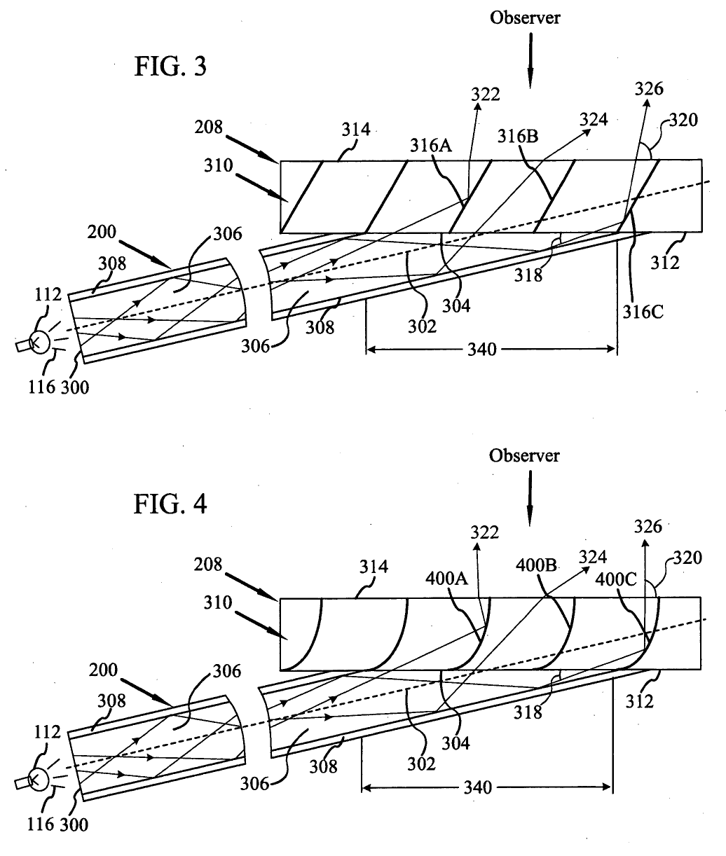

FIG. 3 conceptually illustrates a cross section of a single light guide 200 and portion of louver device 208 as used in a light guide screen. As shown, input end 300 may be substantially transverse to longitudinal centerline 302. Output end 304 is at an acute angle relative to longitudinal centerline 302.

In at least one embodiment, the light guides 200 comprising the light guide screen are optical fibers, each having a longitudinal light guide core 306 and an external circumferential cladding 308. It is, of course, realized that light guide 200 may bend, coil, or otherwise contour such that it may not always lie in a straight line. However, light guide 200 is shown as straight for ease of discussion and illustration.

In at least one embodiment, the core 306 is formed of a generally optically clear plastic or plastic-type material, including but not limited to a plastic such as acrylic, Plexiglas, polycarbonate material, and combinations thereof. In an alternative embodiment, the core 306 is formed of a generally optically clear glass.

In at least one embodiment, each light guide 200 is preferably substantially totally internally reflecting such that the light, illustrated as lines 116, received at the input end 202 from image source 112 is substantially delivered to the magnifying output end 206 with minimal loss. Cladding 308 is a material having a refraction index lower then that of the core 306. Total internal reflection, or TIR, is the reflection of all incident light off a boundary between cladding 308 and core 306. TIR only occurs when a light ray is both in a more dense medium and approaches a less dense medium, and the angle of incidence for the light ray is greater than the “critical angle.” In this example, the core 306 is denser than the cladding 308.

The critical angle is defined as the angle of incidence measured with respect to a line normal to the boundary between the two optical media for which light is refracted at an exit angle of 90 degrees—that is, the light propagates along the boundary—when the light impinges on the boundary from the side of the medium of higher index of refraction. For any angle of incidence greater than the critical angle, the light traveling through the medium with the higher index of refraction will undergo total internal refraction. The value of the critical angle depends upon the combination of materials present on each side of the boundary.

However, the beveling of output end 304 is likely to substantially change the angle of incidence of light 116 as it encounters output end 304. More specifically the angle of output end 304 relative to longitudinal centerline 302 will either increase or decrease the angle of incidence.

Within a typical light guide 200 such as, for example, optical fibers, the spread of light to either side of longitudinal centerline 302 is typically about 30 degrees. Although the angle of output end 304 may provide a flat surface transverse to a viewer, exiting light will continue substantially in the direction last suggested by longitudinal centerline 302, unless reflected or refracted at output end 304.

Where the angle of incidence is increased, the light 116 may be reflected at such an angle so as to not properly bounce internally again; rather, the light may exit the back side of the light guide 200. Where the angle of incidence is decreased, the light 116 may exit from output end 304 at a very flat angle relative to output end 304. In certain settings, the loss of light provided to the observer can be about 50%.

In most environments, an observing party will most likely be viewing from a location transverse to the output end 304 shown in FIGS. 3 and 4. Of the delivered light 116 emerging from output end 304 that is not sharply reflected through the back of light guide 200, the direction of propagation will be substantially in line with longitudinal centerline 302 and will have an annular field of view substantially the same as the angle of acceptance of the light guide 200. This may be a field of view that is both smaller than desired and oriented away from a normalized viewing location.

To reduce the loss of light, improve the viewing angle provided to an observer, and provide other advantages, an appropriate louver device 208 is disposed upon output end 304. As further described below, louver device 208 receives light at acute angle of incidence and directs the light out the outer surface (viewing surface 104 in FIG. 1) at a near normal angle of incidence.

In at least one embodiment, louver device 208 consists of a translucent layer of material 310, having an inner surface 312 and, parallel thereto, an outer surface 314. Translucent layer of material 310 may also be referred to as a sheet of translucent material. A plurality of reflective louver members (illustrated as thick black lines 316) are disposed at least partially within the assembled louver device 208. In at least one embodiment, inner surface 312 is configured to join to the light guide screen, such as by a substantially transparent glue. In yet another embodiment, louver device 208 is configured to removably attach to a LGS 100, such as by snaps, a tongue-and-groove system, Velcro, screws, or other such appropriate non-permanent attachment device.

Louver members 316 are aligned to receive light 116 entering the inner surface 312 from output end 304 of light guide 200 at a low angle 318 relative to inner surface 312 and direct light 116 out the outer surface 314 at a high angle 320 relative to the outer surface 314. As such, in FIG. 3 all three illustrated light arrows 322, 324, 326 are traveling generally towards the viewing observer. As substantially all of the light 116 is directed from light guide 200 out through outer surface 314 towards an observer, louver device 208 incorporating louver members 316 advantageously enhances the contrast abilities of LGS 100.

In at least one embodiment, the index of refraction for translucent layer 310 will be substantially the same as the index of refraction of the light guide cores establishing the light guide screen. Having substantially the same index or refraction the boundary between output end 304 and inner surface 312 will not significantly reflect light 116. In other words, light 116 from light guide 200 will not be reflected out the back side of light guide 200.

When reflected from a plane mirror, such as louver member 316, the delivered light will likely emerge from the outer surface 314 with an annular field of view normalized to the outer surface 314, but substantially the same as angle of acceptance as that of light guide 200. By providing cylindrical or elliptical mirror elements with appropriate focusing power in the horizontal and vertical directions, the spread of light from the display may be expanded to provide an enhanced viewing zone.

FIG. 4 illustrates as yet another embodiment of a louver device 208 wherein the louver members are elliptical (represented as thick black curved lines 400). In at least one embodiment, louver members 400 are cylindrical mirror segments. In an alternative embodiment, louver members 400 are elliptical mirror segments. Whether cylindrical or elliptical, louver members 400 are provided with appropriate focusing power in the horizontal and vertical directions to spread light 116 emerging from outer surface 314 over a desired viewing zone. As substantially all of the light 116 is directed from light guide 200 out through outer surface 314 towards an observer, louver device 208 incorporating louver members 400 advantageously enhances the contrast abilities of LGS 100 and permits a wide range of predetermined viewing angles.

The LGS 100 (see FIG. 1) comprises a plurality of pixels. With respect to FIGS. 3 and 4, the output end 304 of each light guide 200 may define the length, and/or height of each pixel. The cross sectional view provided in FIGS. 3 and 4 shows the horizontal width 340 of a pixel.

So as to effectively redirect light 116 from output end 304 to an observer, the louver members 316, 400 are aligned to transversely cross output end 304. Output ends 304 repeat with periodicity in providing the viewing surface 104 of LGS 100 (see FIG. 1). The louver members 316, 400 also repeat with periodicity. In at least one embodiment incorporating either louver members 316 or louver members 400, the louver members 316, 400 are spaced at regular intervals and each louver member is substantially identical. In at least one embodiment, louver members 316, 400 are arranged in parallel rows

When two periodic structures are close to the same periodicity or simple fractions thereof and disposed proximate to one another, visible fringe patterns may occur. In at least one embodiment, the potential for such fringe patterns may be significantly reduced by spacing louver members 316, 400 at intervals about one-third the size 400 of each pixel which interval is optimal for pixel resolution with reduction in fringing patterns. There is little change if the intervals are smaller. However, as intervals approach 1/2 or more of the pixel size, fringing patterns become problematic and resolution can be degraded.

Moreover, as shown in FIG. 3, louver members 316 are appropriately spaced such that three louver members (316A, 316B, 316C) are provided across the length of output end 304. Likewise in FIG. 4, louver members 400 are appropriately spaced such that three louver members (400A, 400B, 400C) are provided across the length of output end 304.

In at least one embodiment, louver members 316, 400 are physical reflective surfaces. Moreover, in at least one embodiment, louver members 316 as shown in FIG. 3 are physical reflective surfaces disposed within translucent layer 310. Louver members 316 are aligned to at least one predetermined angle. Likewise, in at least one embodiment, louver members 400 as shown in FIG. 4 are physical reflective surfaces disposed within translucent layer 310. Louver members 400 are aligned to at least one predetermined angle.

In at least one alternative embodiment, holographic reflectors provide apparent lover members that are substantially similar to louver members 316 as shown in FIG. 3 and louver members 400. With respect to providing elliptical or spherical mirrors, which for physical reflective surfaces may require specialized tooling and manufacturing processes, holograms may simplify the manufacturing process and improve the consistency of louver device 208.

Described generally, holograms work by recording the interference patterns of light on a holographic film or plate. Light may be described as a wave, having crests and troughs. To create a hologram, typically a laser beam is split—the first beam being the reference beam directed onto a photosensitive medium, and the second beam reflected off a target object. The photosensitive medium is placed near the target object so that it will receive light from the second beam as it is reflected off the target object as well as the direct light from the first beam.

The direct light of the first beam and the reflected light of the second beam combine and interfere with one another. The crests and troughs of the reflected light will be slightly different from the crests and troughs of the reference light. This difference leads to a specific interference pattern on the photosensitive medium.

When the photosensitive medium (a plate) is developed to fix the interference pattern, the image may be recreated by directing coherent light onto the plate. The interference patterns fixed on the plate diffract the beam and produce a replica of the recorded image. If the emulsion is thick compared to a wavelength of the light used, and the interference pattern recorded on the plate contains significant variations in the thickness direction of the emulsion, then the holograms produced by this process are known as Bragg holograms.

In at least one embodiment, the reflective louver member 316, shown in FIG. 3, are surfaces providing holograms. As such, a generally flat structure may provide holographic louvers that provide substantially the same benefits as the elliptical louvers 400, illustrated and described with respect to FIG. 4. In at least one embodiment, the holograms provided on louver members 316 are embossed holograms. Embossed holograms can be rendered using a photographic hologram as a template, or even a computer rendered dot matrix hologram. In an embossed hologram, the embossed ridges provide the interference diffraction patterns. As the louver members 316 providing the holograms are physically spaced some distance apart, the embossed holograms may be coated with reflective material so as to both diffract and reflect the incident light.

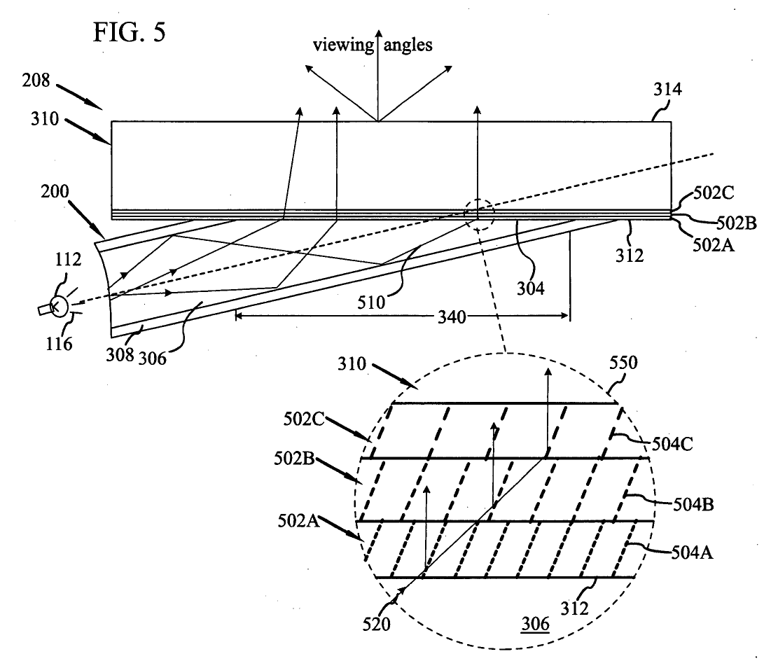

FIG. 5 is an enlarged cross-sectional view of a single light guide 200 and portion of louver device 500 as used in a light guide screen. The illustration has been enlarged and exaggerated to show at least one holographic material layer 502 that has been added to the translucent layer 310. More specifically, three holographic material layers 502A, 502B, 502C are shown. In this example, each holographic material layer corresponds to a primary color (red, green, blue). It is to be understood that louver device 208 as shown in FIGS. 2, 3 and 4 may be a holographic louver device substantially identical to louver device 500. Further, it is understood and appreciated that there may be more than three layers and more than three primary colors used in louver device 208.

In at least one embodiment, the at least one holographic material layer 502 is a photosensitive coating, such as a photopolymer material available from and provided by DuPont for the purpose of rendering photo-holograms. The thickness of the coating may be only as thick as needed for effective hologram rendering, although shown in FIG. 5 in exaggerated size for ease of discussion and illustration. So as to avoid unintended boundary reflections, the photosensitive coatings are generally selected to have similar indexes of refraction to the light guide core 306 and translucent material 310.

The enlarged partial cross section bounded by dotted circle 550 conceptually illustrates the fringe patterns 504 (illustrated as dotted lines) recorded in holographic material layer 502. More specifically, holographic material layer 502A has fringe patterns 504A, holographic material layer 502B has fringe patterns 504B, and holographic material layer 502C has fringe patterns 504C. The spacing between fringe patterns 504C is larger than the spacing between fringe patterns 504B and 504A, so as to represent the different wavelength of light each layer 502A˜502C will refract. The represented fringe patterns 504A˜504C are enormously larger and farther apart then actual holographic fringe patterns.

As illustrated light 510 passes from the core 306 into each successive holographic material layer 502A˜502C. Each wavelength component of light 510 is properly re-directed by the corresponding fringe pattern 504A˜5045C. Although illustrated as individually distinct fringes, each reflective hologram may in actually be a continuous hologram that simply bends the light by the required amount and disperses it over the desired viewing angles.

Moreover, holographic material layers 502A˜502C are configured to have a diffractive characteristic that reflects light received from output end 302 of light guide 200 at an oblique angle relative to inner surface 312 through translucent layer 310 and out the outer surface dispersed over the required viewing angles relative to outer surface 314. Moreover, the holographic reflectors represented by fringe patterns 504A˜504C are so configured to diffract planar light waves received at inner surface 312 to the output surface 314.

In at least one embodiment, the holographic reflectors established by the recorded fringe patterns 504A˜504C are representations of plane mirror surfaces. In an alternative embodiment, the holographic reflectors established by the recorded fringe patterns 504A˜504C are representations of cylindrical or ellipsoidal mirror segments.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A light guide screen louver device comprising:
a translucent layer of material having an inner surface and, parallel thereto, an outer surface;
a plurality of reflective louver members disposed within the layer of material, the louver members aligned to receive light entering the inner surface from the light guide screen at a low angle relative to the inner surface and direct the light out the outer surface at a high angle relative to the outer surface;
wherein the louver device is configured to join to the light guide screen.

2. The light guide screen louver device of claim 1, wherein light is provided to the inner surface by a plurality of light guide screen pixels, each pixel having a diameter D, spacing between the louver members being less than D.

3. The light guide screen louver device of claim 2, wherein the spacing between the louver members is about ⅓ D.

4. The light guide screen louver device of claim 1, wherein the louver member are arranged in parallel rows.

5. The light guide screen louver device of claim 1, wherein the louver members are transverse to light provided to the inner surface by a plurality of light guide screen light guides.

6. The light guide screen louver device of claim 1, wherein the light guide display includes a plurality of light guides, each having a light delivering core with an index of refraction, the translucent layer of material having an index of refraction substantially identical to core index of refraction.

7. The light guide screen louver device of claim 1, wherein the louver members are physical reflective surfaces.

8. The light guide screen louver device of claim 1, wherein the louver members are holographic reflectors.

9. The light guide screen louver device of claim 8, wherein each holographic reflector represents an elliptical mirror segment, the elliptical mirror property providing an increased angular range of light guide screen viewing.

10. A light guide screen louver device comprising:
a translucent layer of material having an inner surface and, parallel thereto, an outer surface;
a plurality of holographic louver members established at least partially within the translucent layer of material, the holographic louver members aligned to receive light entering the inner surface from the light guide screen at a low angle relative to the inner surface and direct the light out the outer surface at a high angle relative to the outer surface.

11. The light guide screen louver device of claim 10, wherein each holographic reflector represents an elliptical mirror segment, the elliptical mirror property providing an increased angular range of light guide screen viewing.

12. The light guide screen louver device of claim 10, wherein the translucent layer of material further includes at least one photosensitive coating providing as at least one holographic material layer.

13. The light guide screen louver device of claim 12, wherein the louver holograms are Bragg hologram patterns.

14. The light guide screen louver device of claim 10, wherein light is provided to the inner surface by a plurality of light guide screen light guides, each guide having a diameter D, spacing between the holographic louvers being less than D.

15. The light guide screen louver device of claim 14, wherein the spacing between the holographic louvers is about ⅓ D.

16. A light guide screen louver device comprising:
a translucent layer of material having an inner surface and parallel thereto, an outer surface, the layer including one or more holographic material layers;
a plurality of holographic louver members established within the one or more holographic material layer, the holographic louver members aligned to receive light entering the inner surface from the light guide screen at a low angle relative to the inner surface and direct the light out the outer surface at a high angle relative to the outer surface;
wherein the louver device is configured to join to the light guide screen.

17. The light guide screen louver device of claim 16, wherein the one or more holographic material layers are established with one or more photosensitive coatings.

18. The light guide screen louver device of claim 16, wherein three holographic material layers are provided, a first holographic layer configured to reflect red light, a second holographic layer configured to reflect green light, and a third holographic layer configured to reflect blue light.

19. The light guide screen louver device of claim 16, wherein the louver holograms are Bragg hologram patterns.

20. The light guide screen louver device of claim 16, wherein each holographic reflector represents an elliptical mirror segment, the elliptical mirror property providing an increased angular range of light guide screen viewing.

21. The light guide screen louver device of claim 16, wherein the holographic louvers are surface relief holograms.

22. The light guide screen louver device of claim 16, wherein light is provided to the inner surface by a plurality of light guide screen light guides, each guide having a diameter D, spacing between the holographic louvers being less than D.

23. The light guide screen louver device of claim 22, wherein the spacing between the holographic louvers is about ⅓ D.

24. A rear projection display comprising:
a plurality of rows, each row including a plurality of light guides, each having a light transmitting core with an index of refraction, each light guide having an input end and an output end, the plurality of output ends collectively grouped as a first output layer;
a translucent layer of material having an inner surface adjacent to the first output layer and parallel thereto, an outer surface, the translucent layer of material having an index of refraction about the index of refraction of the light guide cores;
a plurality of louver members disposed within the layer of material, the louver members aligned to receive light entering the layer from the output ends with a an acute angle of incidence, and direct the light out the outer surface of the translucent material at a near normal angle of incidence.

25. The rear projection display of claim 24, wherein the louver members are holographic reflectors, each holographic reflector representing an elliptical mirror segment, the elliptical mirror property providing an increased angular range of light guide screen viewing.

26. A rear projection display comprising:
a plurality of rows, each row including a plurality of light guides each having a light transmitting core with an index of refraction, each light guide having an input end and an output end, the plurality of output ends collectively grouped as a first output layer;
a translucent layer of material having an inner surface joined to the first output layer and, parallel thereto, an outer surface, the translucent layer of material having an index of refraction about the index of refraction of the light guide cores;
a plurality of holographic louver members established at least partially within the translucent layer of material, the holographic louver members aligned to receive light entering the layer from the output ends and direct the light out of the outer surface of the material at a near normal angle of incidence.

27. The light guide screen louver device of claim 26, wherein the light guides intersect the first output layer at a low angle relative to the first output layer, the holographic louver member reflecting the light through the outer layer at a high angle relative to the first output layer.
